(19) United States
(12) Patent Application Publication
(10) Pub. No.: US 2013/0066748 A1
(43) Pub. Date: Mar. 14, 2013

(54) ARCHITECTURAL OPENING COVERING ORDERING METHOD AND SYSTEM

(71) Applicant: Eric LONG, Roswell, GA (US)

(72) Inventor: Eric LONG, Roswell, GA (US)

(21) Appl. No.: 13/608,670

(22) Filed: Sep. 10, 2012

Related U.S. Application Data
(60) Provisional application No. 61/532,935, filed on Sep. 9, 2011.

(51) Int. Cl. G06Q 30/06

(52) U.S. Cl. 705/27.1

(57) ABSTRACT

A method for ordering and entering measurements for installing coverings for architectural openings may include receiving consumer information for measurement of an architectural opening. The method may also include transmitting a measurement request to a communications device of a covering installer for scheduling measurement of the architectural opening in response to receiving the consumer information. The method may additionally include presenting a measurement GUI for entering measurements of the architectural opening and other information associated with the architectural opening and storing the measurements for the architectural opening in a database. The method may additionally include transmitting a request to the consumer to access a website for selecting a covering for the architectural opening based on the measurements. The method may further include presenting a covering selection GUI for selecting and ordering the covering for the architectural opening.

### CROSS-REFERENCE TO RELATED APPLICATIONS

The present application claims benefit of priority to U.S. Provisional Application No. 61/532,935 filed on Sep. 9, 2011, the contents of which are hereby incorporated by reference herein in its entirety.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND

Aspects of the present invention relate to shopping, ordering, measuring and installing coverings for architectural openings, such as windows and other openings, and more particularly to a method, system and computer program product for shopping, ordering, measuring and installing coverings for architectural openings.

Ordering coverings for architectural opening, such as windows and other architectural openings can be a burdensome and often frustrating experience for the consumer. The process is mostly handled on a referral basis that leaves the consumer burdened with initiating communication with an installer. More importantly, there is no system in place to manage the professional measurements the installer provides for the consumer to select window coverings and place an order. Because of the number of measurements that may be taken and the precision required for entering the right measurements for each and every window covering to be installed in a home or other structure, there exists a high probability for error. Since installers only guarantee their measurements and not how the measurements are entered into any system by the consumer errors can result. Furthermore, this can cause inconvenience and confusion as the consumer separately manages the installation process from the purchase process with no system tying the two processes together.

### BRIEF SUMMARY

According to an aspect of the present invention, a method for ordering and entering measurements for installing coverings for architectural openings may include receiving, by a computer system, consumer information for measurement of at least one architectural opening associated with a consumer. The method may also include transmitting, by the computer system, a measurement request to a communications device of a covering installer for scheduling measurement of the at least one architectural opening in response to receiving the consumer information. The method may additionally include presenting, by the computer system, a measurement GUI for entering measurements of the at least one architectural opening and other information associated with the at least one architectural opening and storing the measurements for the at least one architectural opening in a database. The method may additionally include transmitting, by the computer system, a request to the consumer to access a website for selecting a covering for the at least one architectural opening based on the measurements. The method may further include presenting, by the computer system, a covering selection GUI for selecting and ordering the covering for the at least one architectural opening.

According to another aspect of the present invention, a system for ordering and entering measurements for installing coverings for architectural openings may include at least one processor and an installer module operating on the at least one processor for receiving and storing measurements for at least one architectural opening and other information associated with the at least one architectural opening. The system may also include a database for storing the measurements for the at least one architectural opening and the other information. The system may additionally include an e-commerce module operating on the server for selecting and ordering at least one covering for the at least one architectural opening. The e-commerce module is operable to present to a consumer a plurality of options for the at least one covering based at least in part on the stored measurements.

According to a further aspect of the present invention a computer program product for ordering and entering measurements for installing coverings for architectural openings may include a computer readable storage medium having computer readable program code embodied therewith. The computer readable program code may include computer readable program code configured to receive consumer information for measurement of at least one architectural opening associated with a consumer. The computer readable program code may also include computer readable program code configured to transmit a measurement request to a communications device of a covering installer for scheduling measurement of the at least one architectural opening in response to receiving the consumer information. The computer readable program code may additionally include computer readable program code configured to present a measurement GUI for entering measurements of the at least one architectural opening and other information associated with the at least one architectural opening. The computer readable program code may also include computer readable program code configured to store the measurements for the at least one architectural opening in a database. The computer readable program code may additionally include computer readable program code configured to transmit a request to the consumer to access a website for selecting a covering for the at least one architectural opening based on the measurements. The computer readable program code may further include computer readable program code configured to present a covering selection GUI for selecting and ordering the covering for the at least one architectural opening.

### BRIEF DESCRIPTION OF THE SEVERAL VIEWS OF THE DRAWINGS

The present invention is further described in the detailed description which follows in reference to the noted plurality of drawings by way of non-limiting examples of embodiments of the present invention in which like reference numerals represent similar parts throughout the several views of the drawings and wherein:

FIGS. 1A-1E (collectively FIG. 1) are a flowchart of an example of a method for ordering and entering measurements for installing coverings for architectural openings in accordance with an embodiment of the present invention.

FIG. 2 is a flowchart of an example of a method for entering measurements for architectural openings in accordance with an embodiment of the present invention.

FIGS. 3A-3G are examples of a series of graphical user interfaces (GUIs) for entering an identification for different architectural openings and for entering measurements and other information associated with each architectural opening in accordance with an embodiment of the present invention.

FIGS. 4A-4C are examples of a series of GUIs for reviewing and selecting different coverings for architectural openings for ordering from a manufacturer or seller in accordance with an embodiment of the present invention.

FIG. 5 is a block schematic diagram of an example of a system for ordering and entering measurements for installing coverings for architectural openings in accordance with an embodiment of the present invention.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create a particular machine and means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

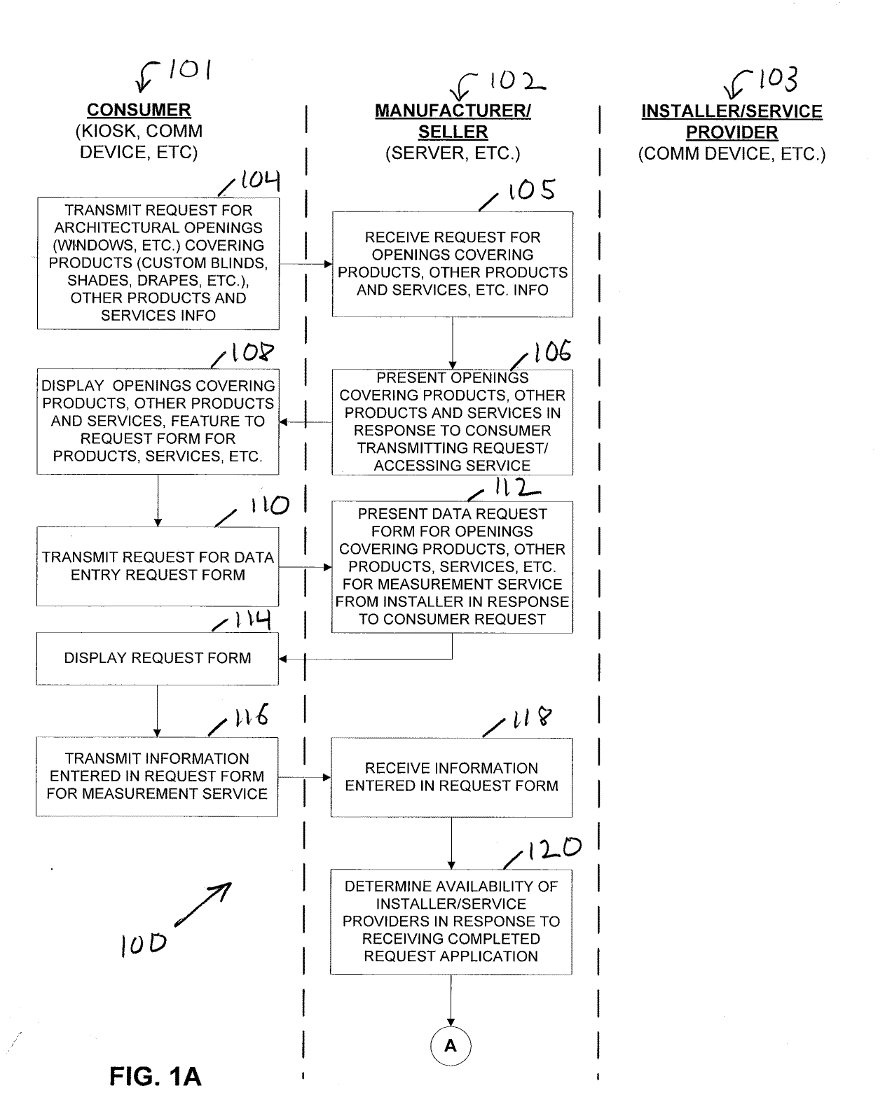

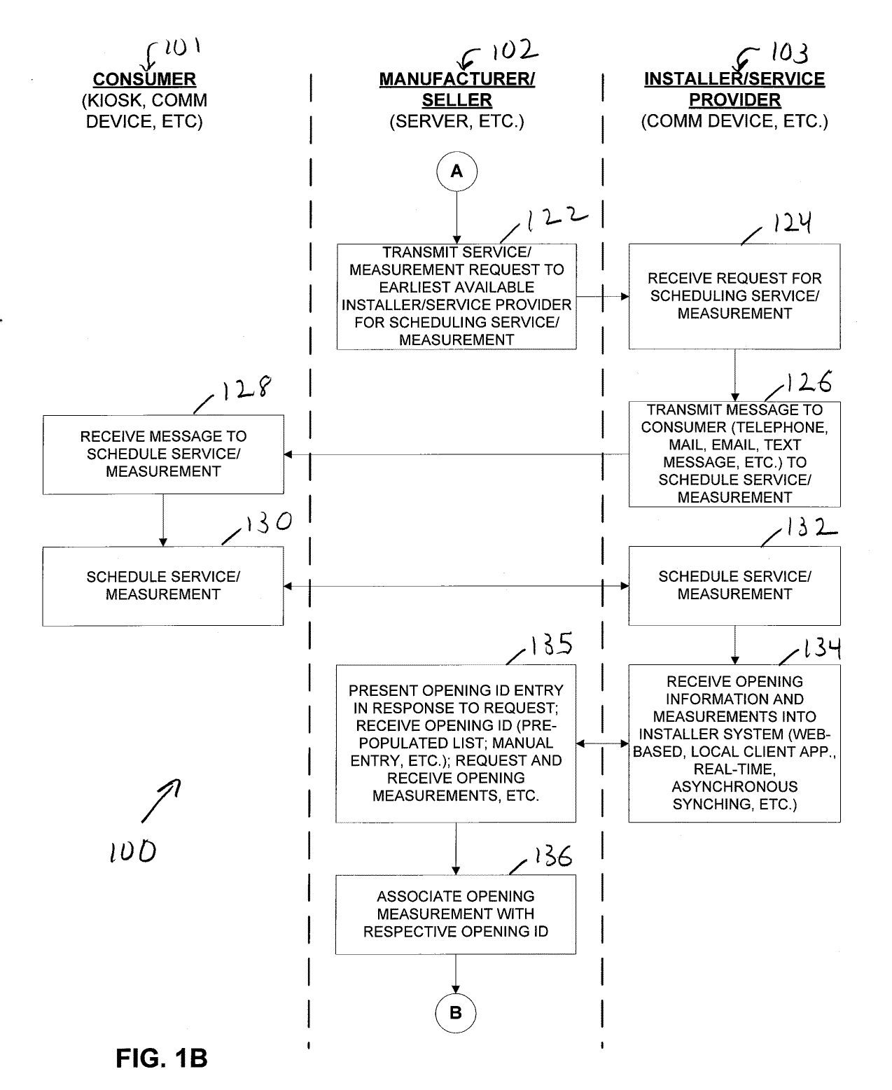

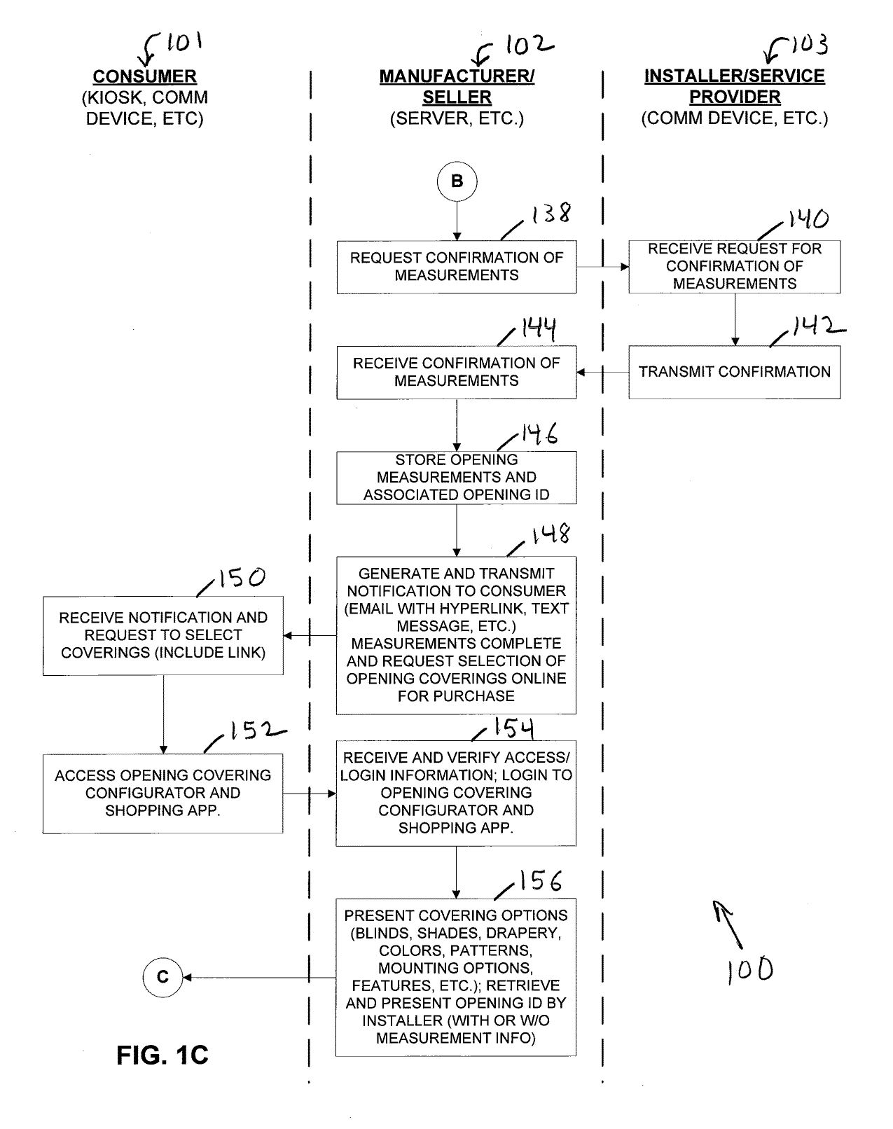

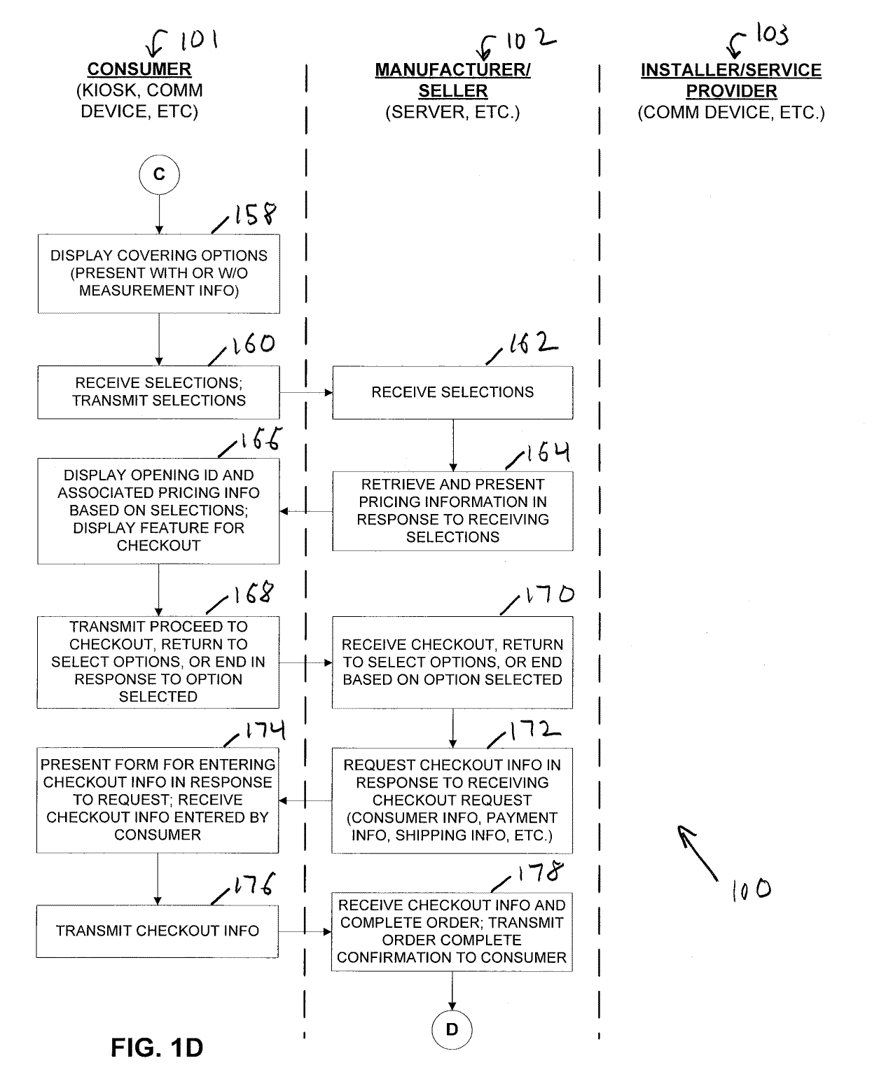

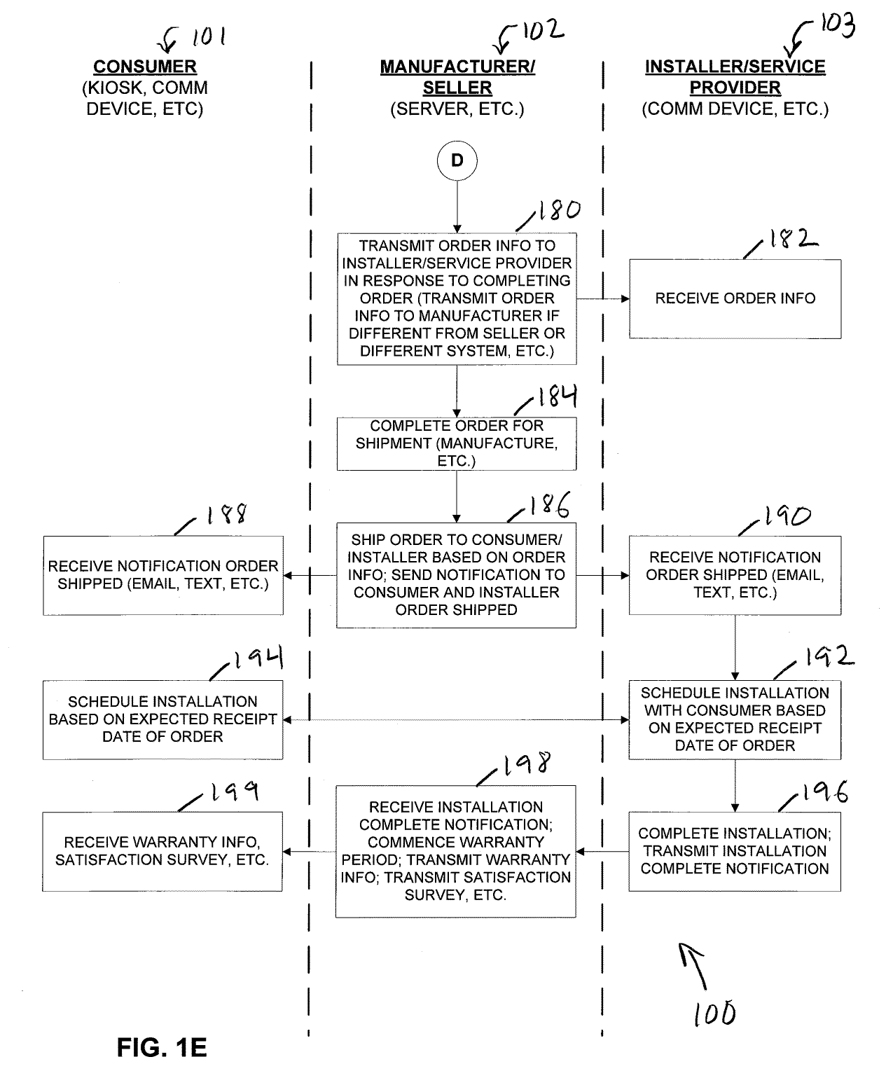

FIGS. 1A-1E (collectively FIG. 1) are a flowchart of an example of a method 100 for ordering and entering measurements for installing coverings for architectural openings in accordance with an embodiment of the present invention. The flowchart is divided into different portions illustrating the different functions or operations that may be performed by different entities or devices. For example, a communications device associated with a consumer or customer may perform functions or operations in portion 101 of the flowchart. A server or other computer device associated with a manufacturer or seller may perform functions or operations in portion 102 of the flowchart and a communications device associated with an installer and service provider may perform functions or operations in portion 103 of the flow chart. The communications device associated with the consumer or customer may be a kiosk including a computer terminal in a retail store, a personal computer, a portable communications device, such as a smart phone, tablet, or other communications device or computing device capable of performing the functions or operations described herein. The communications device associated with the installer and service provider may also be a computer terminal, portable communications device or other device capable of performing the functions or operations described herein.

In a block 104, a request for architectural openings covering products and services may be transmitted to a manufacturer, seller or retailer of such products. Transmitting the request may include the consumer or customer accessing a request application for the covering products, other products and services. The request application may be a website, mobile application kiosk at a retailer or other arrangement to review opening or window covering products and services information and to request measurement service from installer/service provider. As used herein, architectural openings may include but are not necessarily limited to windows and other openings associated with a house, building or other architectural structure. The architectural openings covering products may include custom blinds, shades, drapes or other products that may be associated with architectural openings.

In block 105, the request for openings covering products, other products or services may be received by a server associated with a manufacturer or seller of such products and services. In another embodiment, the request may also be received by a third party server hosting a website for the covering products and services for the manufacturer or seller. In block 106, openings covering products, other products and services may be presented to the consumer in response to the consumer transmitting the request or accessing the website for the architectural openings covering products and services.

In block 108, information associated with the covering products and services may be displayed in a graphical user interface (GUI) on the communications device associated with the consumer to inform the consumer as to the possible products that may be selected and purchased and/or the services associated therewith. The GUI may include a feature to request a request form or data entry form for requesting measurement services of architectural openings. In block 110, the request for the data entry form or request form for requesting measurement services may be transmitted to the server associated with manufacturer or seller. In block 112, the request form may be presented in response to the consumer request. In block 114, the request form may be displayed on the communications device associated with the consumer. The request form may include fields for contact information for the consumer and a brief description or selection of the type of architectural openings for which the consumer desires additional information and/or measurement. At this point, in one embodiment, the specific products, including models, configuration, materials, operational features, add-ons, etc. may not be included, but instead include general description or indication of the type of product which the consumer wishes to purchase.

In block 116, the information entered in the request form or data entry form for measurement service may be transmitted to the server associated with the manufacturer and seller. In block 118, the information entered in the request form may be received.

In block 120, availability of installer and service providers may be determined in response to receiving the completed request form or data entry form in block 118. According to various embodiments, scheduling or workforce management applications or services may be utilized to determine available resources. In block 112, a measurement and/or service request may be transmitted to the earliest available installer/service provider for scheduling service/measurement of the architectural openings of the consumer.

In block 124, the request for scheduling service/measurement may be received by the installer/measurement service provider. In block 126, a message may be transmitted to the consumer to schedule service/measurement of the architectural openings. The message for scheduling the service or measurement may be via telephone, regular mail or via electronic communications, such as e-mail, text messaging or other electronic communications.

In block 128, the message to schedule service/measurement may be received by the consumer. In blocks 130 and 132, the consumer and installer/service provider may communicate with one another to schedule the measurement service.

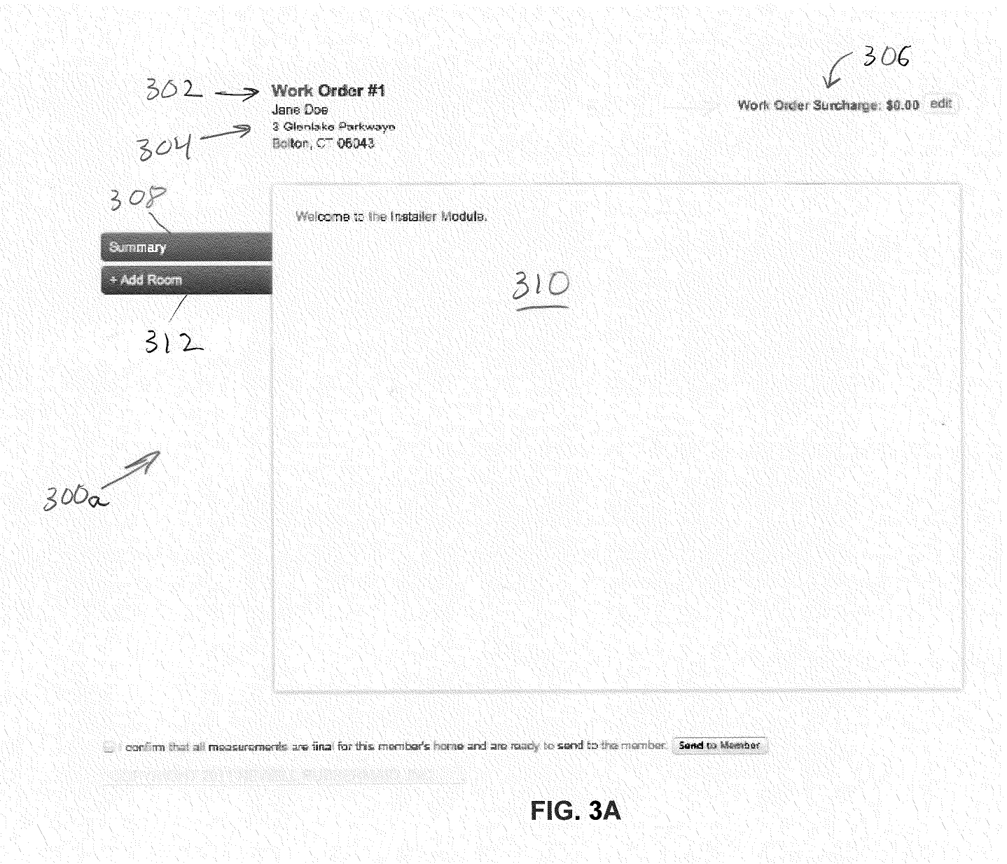

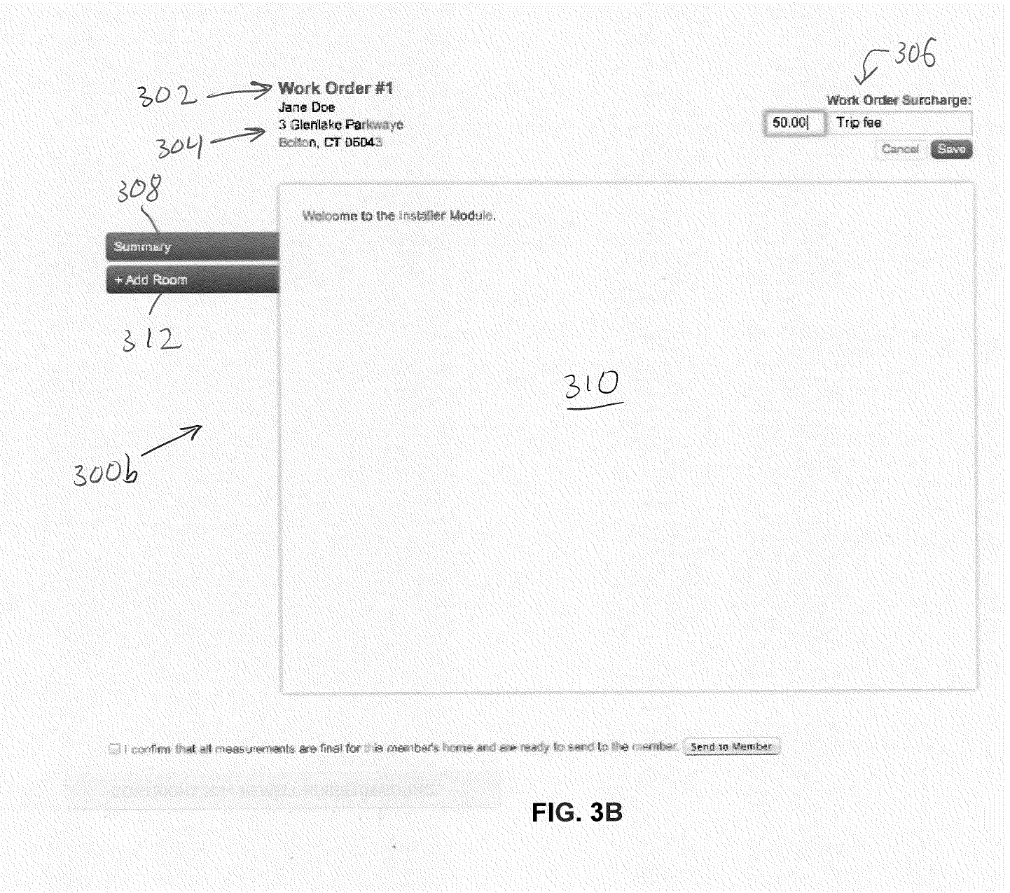

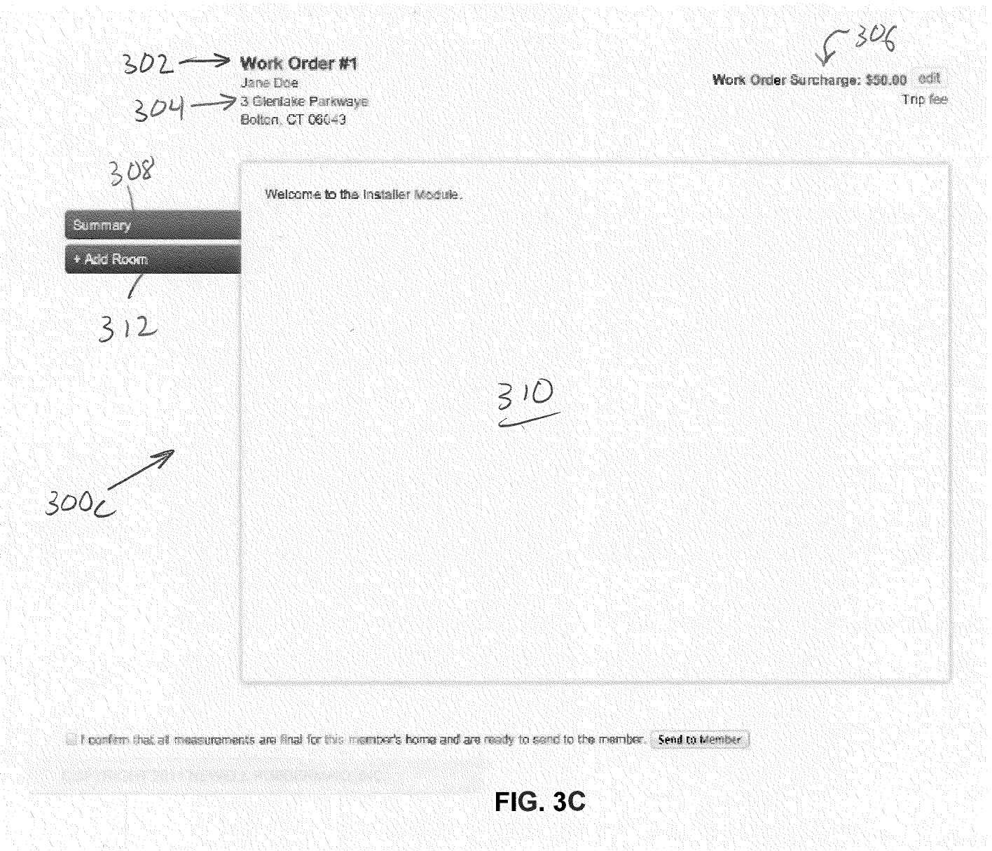

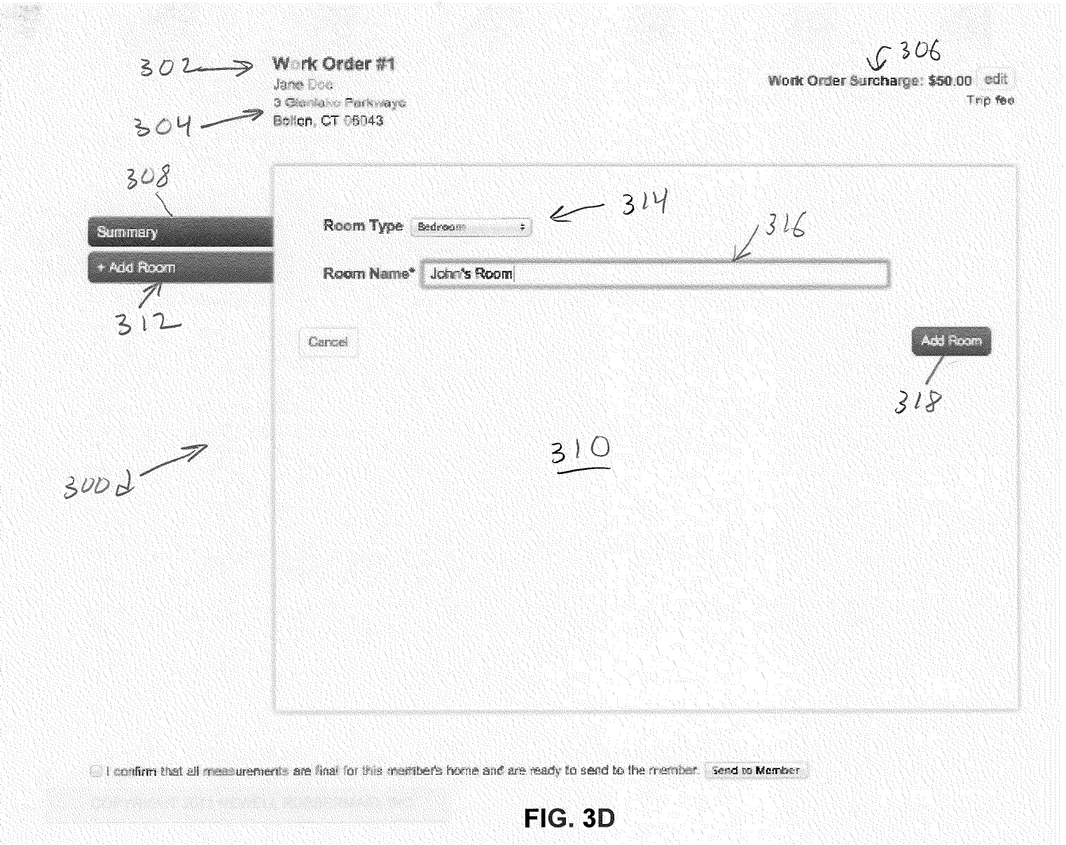

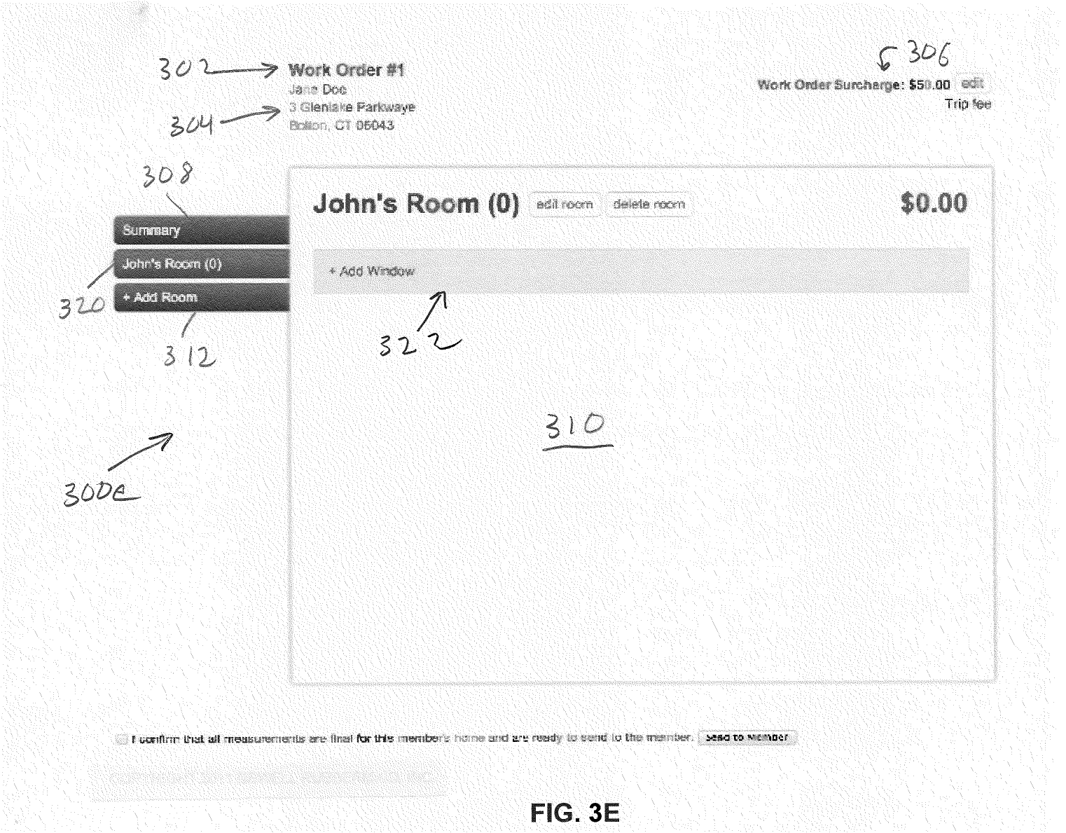

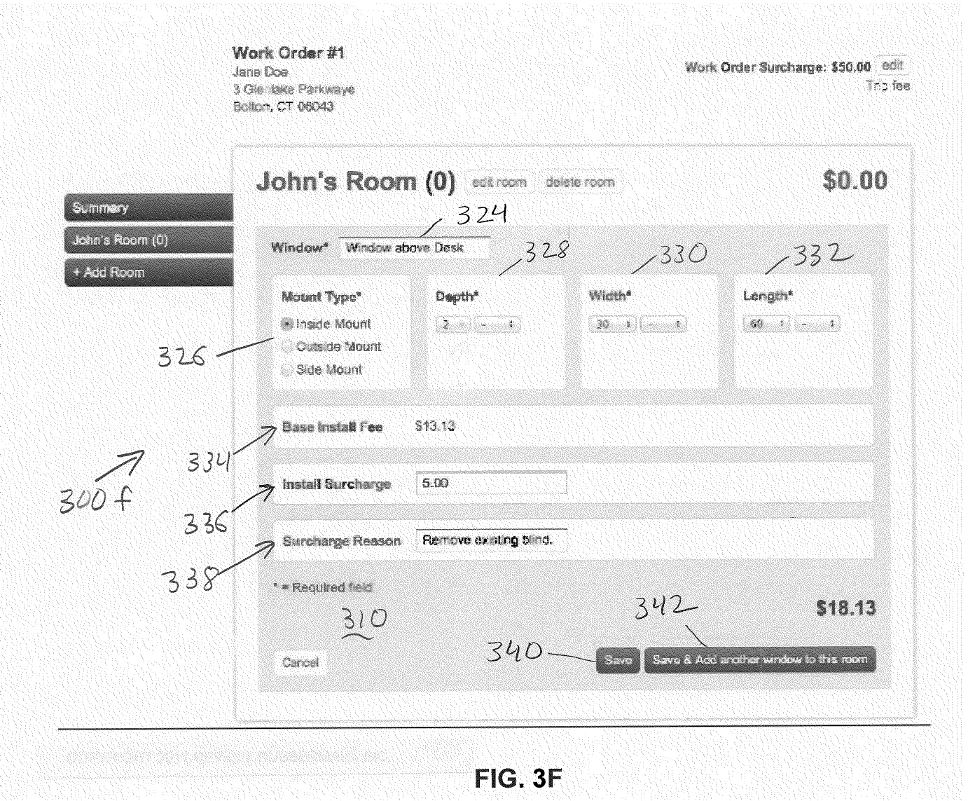

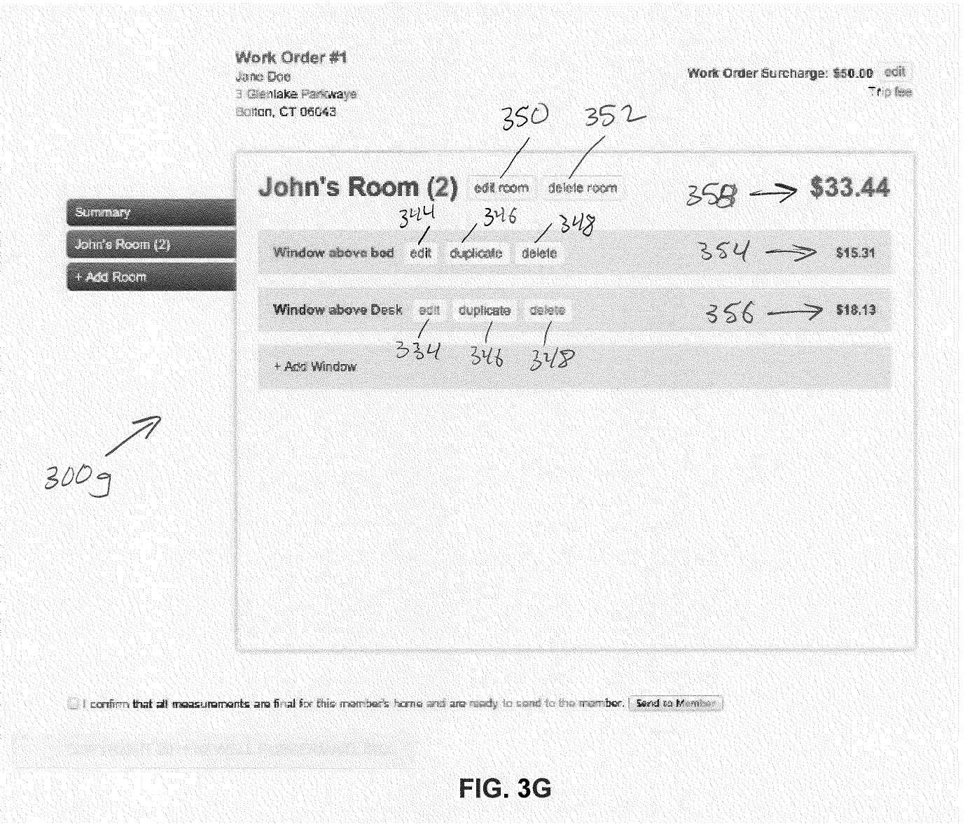

Upon scheduling the service/measurement appointment, the installer or other service provider may visit the consumer's home or other location for which the opening coverings are being purchased and perform the measurements on one or more of the architectural openings. In block 134, opening measurements and information may be received into the installer's system. The measurement and information may be entered into a local client application on a computer system associated with the installer or by some other arrangement. In another embodiment, the opening measurements and related information may be entered directly in the manufacturer's or seller's system. The measurements and related information may be entered via a web-based mechanism. The installer/service provider may access the manufacturer or seller's system for entering the measurements and related information. An example of a series of GUIs for entering the measurements and other information are illustrated in FIGS. 3A-3G.

An opening identification or identifier (ID) entry form may be presented in response to a request to enter the opening measurements and related information. An ID for a particular architectural opening may be entered. A pre-populated list of openings or opening types may be presented in response to entering the opening ID. In another embodiment the openings may be entered manually. The opening ID may be text-based, number-based, alphanumeric. The opening ID may also be associated with one or more rooms or room identifiers similar to that illustrated and FIGS. 3A-3G. One benefit of creating unique room and/or architectural opening identifiers provides both the installers and the consumers a simple means for easy identification of the window or other opening within a particular room. For example, the room and/or architectural openings may be named or other identifiers created during the measurement service by the installer and/or by the consumer (e.g., the consumer naming them for the installer or the installer relying on own naming convention). Thus, when the consumer is shopping for openings after measurements have been performed, the consumer has an easily understood identification of each opening to which the consumer can relate, which in turn simplifies the shopping and selection experience for the consumer. In addition, during actual installation, the installer can easily identify which coverings have been purchased for which architectural openings by way of the previously entered opening and/or room identifiers. Creating this unique identification of the rooms and/or openings and associating the measurement and covering data therewith avoids overly complicated and confusing shopping experience for the customer and greatly reduces the possibility of incorrect installation or other errors by the installer that may otherwise result without such unique identifiers.

Also in block 135 the opening measurements may be requested and received by the manufacturer or seller's system or server (or may be otherwise received by the manufacturer or seller's system or any other system, such as if pushed from the installer/service provider's system). The measurement and information may be uploaded to the manufacturer or seller in real time, by asynchronous synching or by other means.

In block 136, the opening measurements may be associated with the respective opening ID. In one embodiment, this is performed by the installer's system during data entry and prior to transmission. In other embodiments, this may be performed at one or more other points during the process, such as by an installer, manufacturer, or seller back-end system.

In block 138, a confirmation of the measurements may be requested. In block 140, the installer/service provider may receive the request for confirmation of the measurements. In block 142, the confirmation may be transmitted to the manufacturer or seller and the confirmation received in block 144. It is appreciated that in other embodiments, confirmation may not be required, or may be performed at any other points during the process.

In block 146, the opening measurements and associated opening ID may be stored in a database.

In block 148, a notification may be generated and transmitted to the consumer that the measurements have been completed. The notification may advise the consumer that opening coverings may be browsed and selected online for purchase. It is further appreciated that, according to other embodiments, the measurement data may be also be accessible at a retailer through retailer systems, which may allow the consumer to select opening coverings at a retailer with the benefit of physical samples and/or the assistance of an experienced sales associate.

In block 150, the notification and request to select opening coverings may be received by the consumer. The notification and request may include a link to a website for selecting and purchasing the coverings. In block 152, an opening covering configurator and shopping application may be accessed online.

In block 154, access and login information may be received from the consumer and verified. The consumer may be logged in to the opening covering configurator and shopping application in response to verification of the consumer's access and login information.

In block 156, opening covering options may be presented to the consumer by the opening covering configurator and shopping application. The opening covering options may include but not necessarily limited to blinds, shades drapery, colors for these products, patterns, mounting options and other features. Opening IDs (and/or room identifiers) by the installer may be retrieved and presented to the consumer. According to one embodiment, opening IDs (and/or room identifiers) may be presented without the actual measurement information gathered by the installer. One benefit of withholding actual measurement information from the consumer is to prevent the consumer from taking the measurement information to another manufacturer or seller, and thus potentially losing the sale of the products while bearing the measurement expense of the installer. Another benefit for not presenting measurement information to the consumer is to simplify the shopping and selection experience by avoiding the possibility of overwhelming the consumer with measurements in addition to the potentially vast selection of products to choose from.

In block 158, the opening covering options may be displayed on the communications device of the consumer. Architectural opening covering options may be presented and displayed to the consumer by any number of ways. According to one embodiment, a product configurator system may include configuration logic that limits the selection of available covering products to only those that are suitable for the received measurements and/or architectural opening types. For example, some products may not be suitable for certain opening types (e.g., French doors may require a different product than a typical window, or skylights may require a different product than a typical window, or openings in bathrooms may require a different product than those for a living room, etc.). According to various embodiments, the product limitation could be performed for each opening entered, whereby some openings may have displayed different subsets of available products than others given their measurements, type, or location. In other embodiments, the product limitation could be performed based on all of the openings such that the products displayed to the consumer are the same windows, whereby only those products that are available for all of the openings are presented and selectable by the consumer. According to other embodiments, however, product configurator logic may not limit the types of products displayed at all, such as allowing the consumer to browse a complete online catalogue of available products, or limiting according to any other number of techniques.

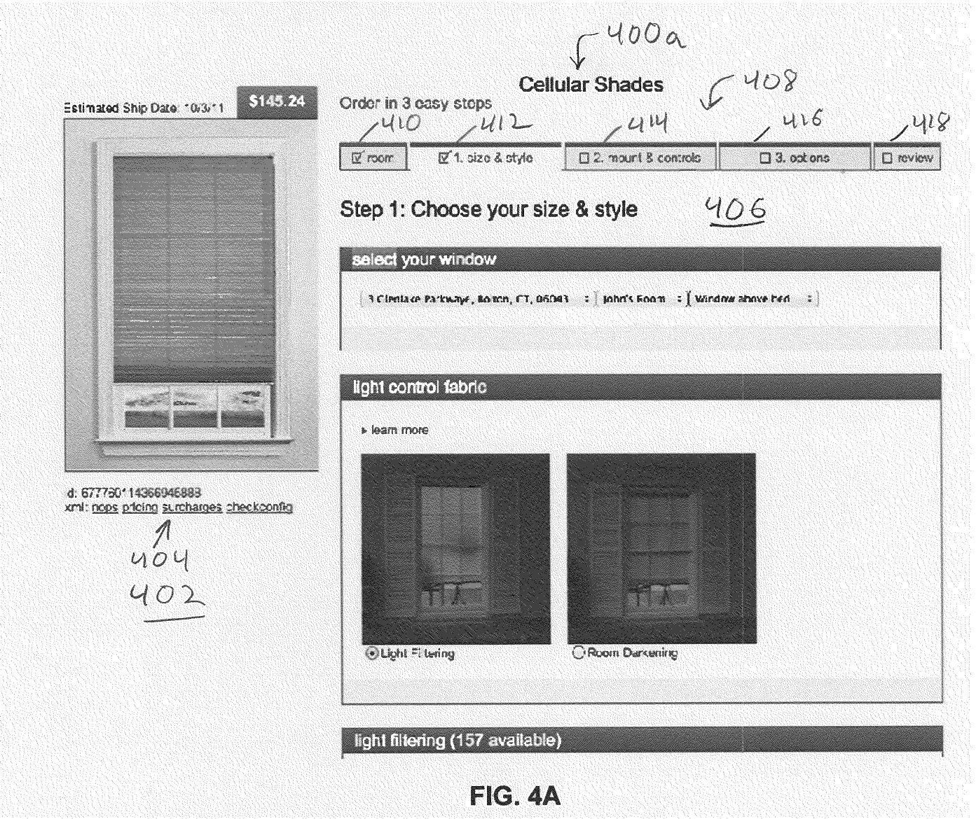

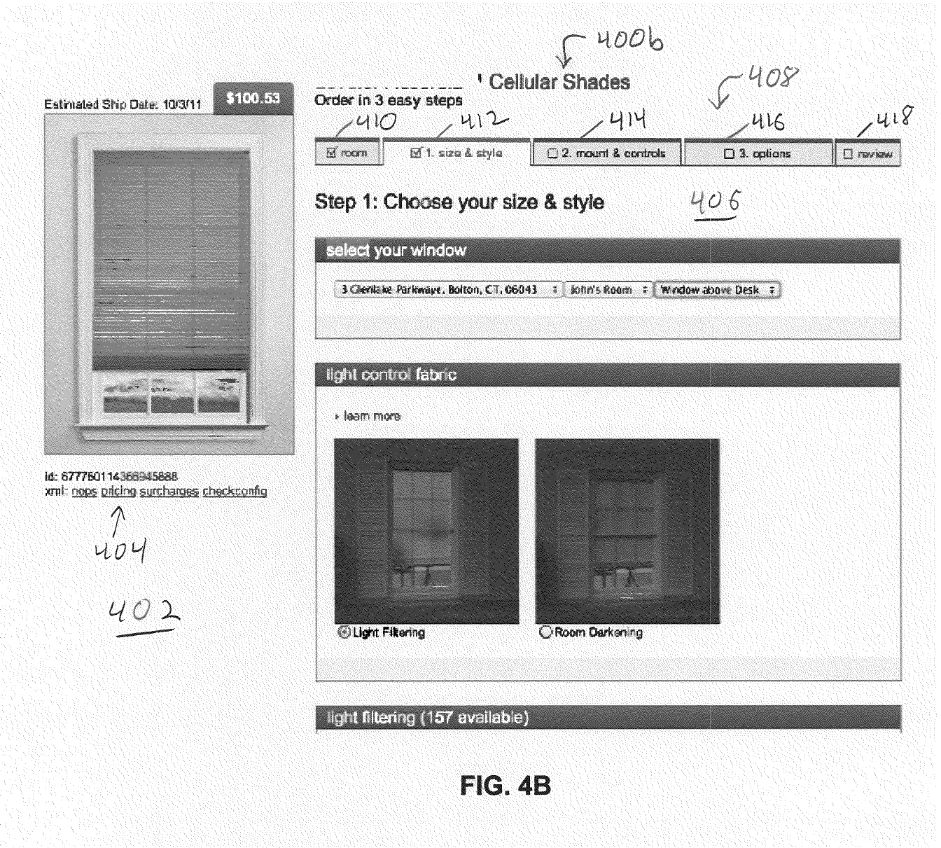

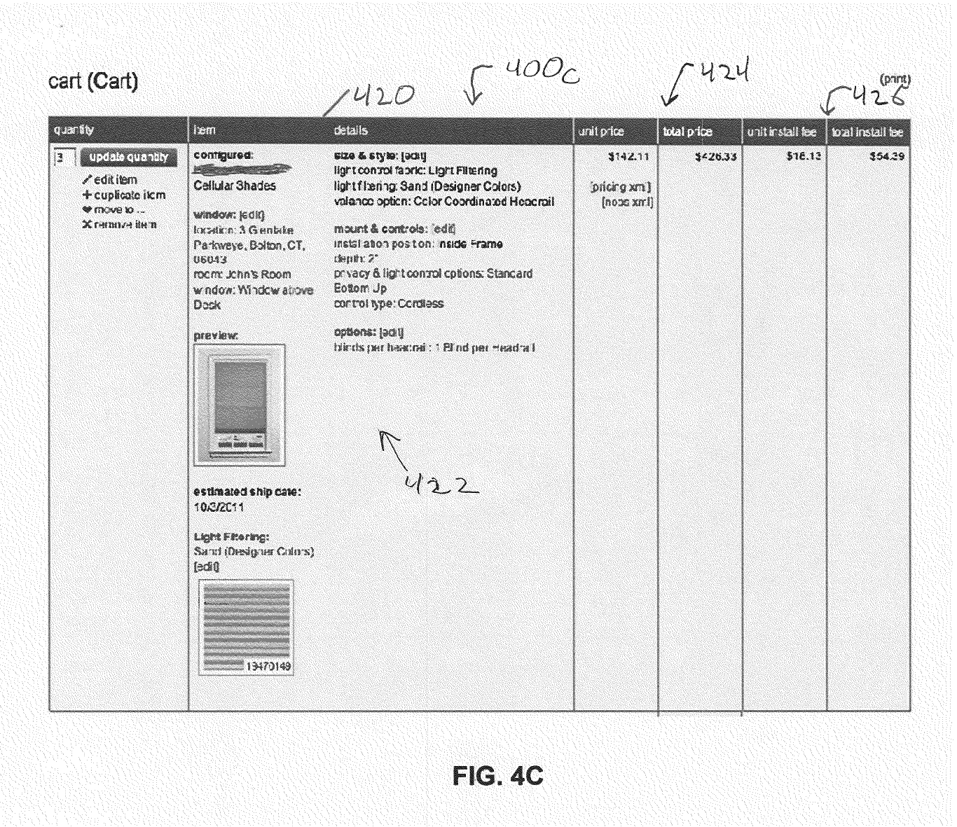

In block 160, selections of options by the consumer may be entered or received by the communications device associated with the consumer and transmitted to the manufacturer or seller. FIGS. 4A-4C illustrate examples of GUI's that may be presented to the consumer for selecting coverings and options.

In block 162, the selections of the consumer are received and in block 164, pricing information may be retrieved and presented to the consumer in response to receiving the selections. It is appreciated that, in some embodiments, pricing information may be presented to the consumer prior to transmitting the products and/or options selected to the manufacturer or seller. For example, the configurator and shopping application may include logic to permit calculating and displaying in real-time or near-real-time the cost based on the various product selections by the consumer. After final decision and adding to the shopping cart, complete purchase information may be transmitted, as described in blocks 166-178.

In block 166, the opening ID and associated pricing information based on the selections may be displayed on the communications device of the consumer. GUI 400c in FIG. 4C is an example of a GUI for presenting the opening ID and associated pricing information and other information based on selections by the consumer in GUIs 400a and 400b in FIGS. 4A and 4B. A checkout feature may be displayed which may be selected by the consumer to proceed to checkout for purchasing and ordering the coverings and options selected.

In block 168, options to proceed to checkout, return to select different options or end the online session may be selected and transmitted to the manufacturer or seller. In block 170, the server may receive the checkout request, return to select options request or end the online session request based on the option selected and transmitted by the consumer in block 168. If the checkout option is received, the method 100 may proceed to block 172. If the return to select options is received, the method 100 may return to block 156 and the method 100 may proceed as previously described. If the end option is received, the method 100 may terminate.

In block 172, checkout information may be requested from the consumer in response to receiving the checkout request from the consumer. In block 174, a data entry form for entering checkout information may be presented or displayed on the communications device associated with the consumer in response to the request to checkout. The consumer may enter the requested checkout information which may include but is not necessarily limited to consumer information (contact information, address information, etc.), payment information (credit card, other form of payment, etc.), shipping information (type of carrier, speed of delivery, etc.) and any other information that may be appropriate for completing the order and shipping the products for installation.

In block 176, the checkout information may be transmitted to the server. In block 178 the checkout information is received and the order may be completed. An order complete confirmation may be transmitted to the consumer in block 178.

In block 180, the order information may be transmitted to the installer/service provider in response to completing the order in block 178. The order information may be transmitted to the manufacturer if the manufacturer is different from the seller or to the manufacturer or seller if a system other than a system associated with the manufacturer or seller completes the order. The order information received from the consumer may be received by the installer/service provider in block 182.

In block 184, the order is completed for shipment. In block 186, the order is shipped to either the consumer or installer based on the order information. A notification is sent to the consumer and the installer that the order has shipped, to whom it was shipped and when the order is expected to arrive. In block 188, the communications device of the consumer may receive the notification that the order shipped and present the notification to the consumer. The notification may be via e-mail, text messaging or by other means. In block 190, the notification that the order shipped may be received by the communications device associated with the installer/provider.

In blocks 192 and 194 the installer and the consumer may communicate with one another to schedule installation of the opening covering based on the expected date of receipt of the order.

In block 196, the installation may be completed and an installation complete notification may be transmitted to the manufacturer and/or seller. In block 198, the installation complete notification may be received by the manufacturer and/or seller. Any warranty period may be started in response to receiving notification that the installation is complete. Warranty information, a satisfaction survey, owner documentation and any other information may be transmitted to the consumer in block 198. In block 199, the communications device associated with the consumer may receive the warranty information, satisfaction survey and any other documentation.

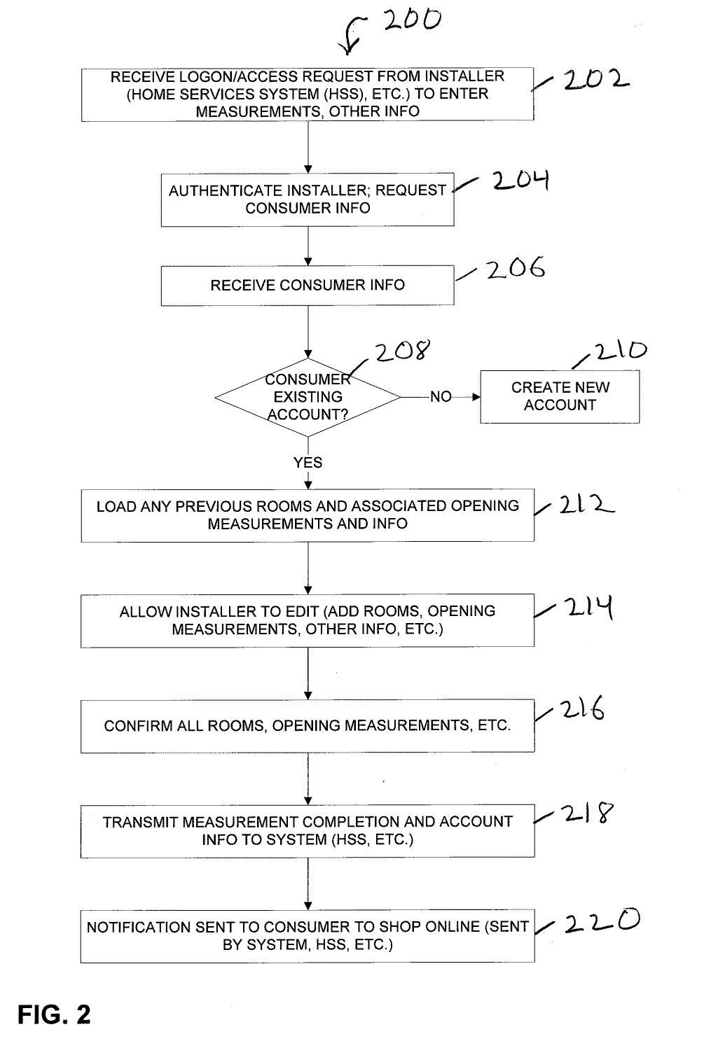

FIG. 2 is a flowchart of an example of a method 200 for entering measurements for architectural openings in accordance with an embodiment of the present invention. The method 200 may embodied in and included at least in part with the installer functions and operations 103 in FIG. 1. For example, the functions and operations in method 200 may be at least partially performed in blocks 134, 140 and 142 of FIG. 1. In block 202, a login/access request may be received from an installer to enter measurements and other information. The installer may be a home services system (HSS) or other entity for performing measurement services of architectural openings and installation services of coverings of architectural openings based on the measurements.

In block 204, the installer may be validated based on the login/access information entered by the installer. The consumer opening covering information may be requested. The installer may need to enter a consumer ID to access or receive the consumer information.

In block 208, a determination may be made whether the consumer has an existing account. If the consumer does not have an existing account, the method 200 may proceed to block 210 and a new account may be created for the consumer. If the consumer does have an existing account, the method 200 may proceed to block 212.

In block 212, any previous rooms and associated opening measurements and information may be loaded and presented to the installer/service provider.

In block 214, the installer may be allowed to edit the room and associated opening information. The installer may edit information for a particular room previously entered and add a room and associated architectural opening measurements and information. The operations and functions in blocks 202-214 may be embodied in block 134 of FIG. 1B.

In block 216, all rooms and associated measurements and information may be confirmed. In block 218, measurement completion and account information may be transmitted to the system of the manufacturer or seller. The operations and functions of blocks 216 and 218 may be embodied in blocks 140 and 142 of FIG. 1C.

In block 220, a notification may be sent to the consumer to shop online in order to select the opening coverings and options based on the opening measurements and other information.

FIGS. 3A-3G are examples of a series of graphical user interfaces (GUIs) 300a-300g for entering an identification for different architectural openings and for entering measurements and other information associated with each architectural opening in accordance with an embodiment of the present invention. The GUIs 300a-300g in FIGS. 3A-3G may illustrate a sequence GUIs based on operation of different features in the GUIs or entry of information in different fields of the GUIs. The GUIs 300a-300g may be generated and presented as part of the functions and operations of blocks 134-144 in FIGS. 1B-1C and blocks 212-214 in FIG. 2.

The GUIs 300a-300g may include a Work Order number 302 and consumer identification information 304. A feature or field for entering or editing a Work Order Surcharge 306 may also be provided. A Summary tab 308 or similar feature may be provided to present a summary of the order in a window 310 of the GUI 330a in response to activation of the Summary tab 308 or feature by a computer pointing device.

An Add Room tab 312 or similar feature may be provided in order to add a room for entering architectural opening measurements associated with the added room. FIG. 3D is an example of a GUI 300d that may be presented in response to activation of the Add Room tab 312 by a computer pointing device. A Room Type field 314 and a field for entering a Room Name 316 may be presented in the window 310 of the GUI 300d. The Room Type field 314 may include a drop-down list for selecting the type of room. An Add Room button 318 may be activated by a computer pointing device to add the room identified in the Room Name field 316. FIG. 3E is an example of the GUI 300e that may be presented in response to activating the Add Room button 318. A Room ID tab 320 or other feature may be provided for selecting the particular room for presentation along with any associated architectural openings in the window 310 of the GUI 300e. The GUI 300e may include an Add Window feature 322 that may be activated using a computer pointing device to add windows or architectural openings to the room currently active or being presented in the window 310.

The GUI 300f in FIG. 3F may be presented in response to activation of the Add Window feature 322 in FIG. 3E. The GUI 300f may include a field 324 for identifying or naming the window or architectural opening; a feature or box 326 for selecting a mounting type of the architectural opening; features or drop-down menus 328, 330 and 332 for selecting the depth, width and length, respectively of the window or architectural opening identified in Window field 324; a field presenting the Basic Install Fee 334; a field for entering and Install Surcharge 336 and a field for entering a Surcharge Reason 338.

The GUI 300f may also include a Save button 340 that may be activated to save the entries for the room named in field 324 and specified in window 310, if there are no other windows to be added to the room. A Save & Add another windows to this room button 342 that may be activated to the save window identified in field 324 specified in the fields in window 310, and to add another window.

GUI 300g is an example of a GUI for adding another window in response to activating the Save & Add another window to the room button 342 using a computer pointing device. The GUI 300g presents each of the architectural openings or windows for the room displayed. Each of the architectural openings or windows identified may include edit, duplicate and delete buttons 344, 346 and 348 respectively for editing, duplicating or deleting the associated window or architectural opening. The GUI 300g may also include an editing room button 350 and a delete room button 352. A cost 354 and 356 for each of the windows or architectural openings may be presented along with a total cost 358 for the room may be presented.

FIGS. 4A-4C are examples of a series of GUIs 400a, 400b and 400c for reviewing and selecting different coverings for architectural openings for ordering from a manufacturer or seller in accordance with an embodiment of the present invention. The GUIs 400a, 400b, 400c may be presented to the consumer for selecting different covering options. GUIs 400a and 400b may include one portion 402 for presenting an image 404 of an exemplary opening or window with the associated opening covering product or products, and another portion 406 that includes a plurality of tabs 408 for different features or options related to the opening and the opening covering products. For example, the tabs 408 may include a “room” tab 410, a “size & style” tab 412, a “mount & controls” tab 414, an “options” tab 416 and a “review” tab 418. The “room” tab 410 may allow a user or consumer to enter a room name or identification. The “size & style” tab 412 may allow the user to enter opening measurements and select style options associated with the opening covering products. The “mount & controls” tab 414 may allow the user to select any mounting and control options associated with the covering products. The “options” tab 416 may allow the user to select any other options associated with the opening covering products, such as color, finish, fabric or other options. The “review” tab 418 may allow the user to review the selected options and to edit or change any of the features or options. The covering products in the image 404 may be altered in response to the different options selected. For example, the products may change color or style according to the color or style selected by the user or consumer.

The GUI 400c is an example of a cart GUI 420 for review of the product or products and product details 422. The cart GUI 420 may also include product price information 424 and installation fees 426.

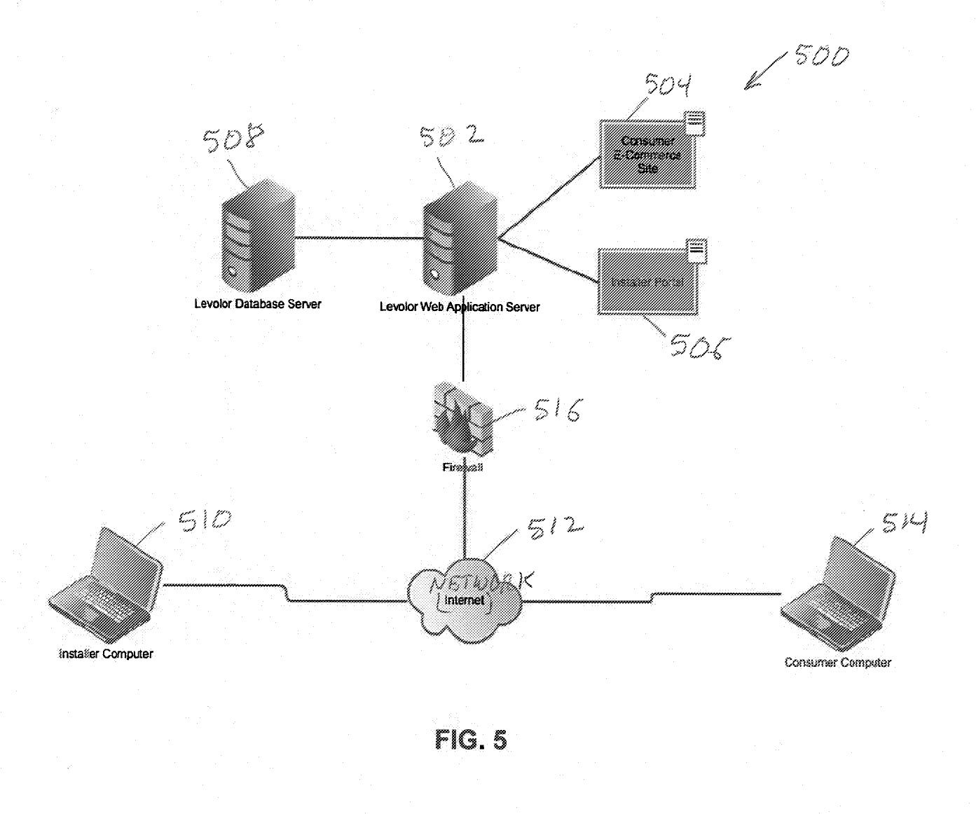

FIG. 5 is a block schematic diagram of an example of a system 500 for ordering and entering measurements for installing coverings for architectural openings in accordance with an embodiment of the present invention. The system 500 may include one or more web application servers 502. The web application server 502 may host one or more consumer E-commerce sites 504 including modules for presenting different architectural opening covering options similar to that described with reference to blocks 158, 160 and 166 and FIG. 1D and may present GUIs similar to exemplary GUIs 400a, 400b and 400c illustrated in FIGS. 4A-4C to permit a consumer to select and purchase different architectural opening options similar to that previously described. The consumer E-commerce site 504 may include an opening covering configurator and shopping application similar to that described with reference to blocks 152-168 in FIGS. 1C-1D.

The Web server 502 may also include one or more installer portals 506 including modules for entering measurements and other information similar to that described with reference to blocks 134 and 135 and FIG. 1B and method 200 described with reference to FIG. 2. The installer portal may present GUIs similar to the exemplary GUIs illustrated in FIGS. 3A-3G.

One or more database servers 508 may also be associated with the web application server 502. The database server 508 may store architectural opening measurement data and other information. The database server 508 may also store a catalogue of different architectural opening coverings and options associated with these coverings for presentation to a consumer for selection and purchase.

One or more installer computer or communications device 510 may access the web application server 502 and the installer portal 506 via a network 512 to perform the functions and operation described herein. The network 512 may be the Internet or other type network. For example, the installer portal 506 may provide or permit access to the functions of managing and communicating with installers or other service providers, including scheduling, capabilities, contact information, rates, service locations, etc. Moreover, it is possible that some or all of the functionality described herein may be performed in part by applications executed by or accessed through the installer portal 506. It is further appreciated that, in some embodiments, the installer communications devices 510 permit installers to access or otherwise execute applications to perform the installation services described herein, which may communicate wired or wirelessly with the installer portal 506, the web server 502, consumer computers 514, any retailer or manufacturer computers, and the like.

A consumer computer or communications device 514 may access the web application server 502 and the consumer E-commerce site 504 via the network 512 to perform the function and operations described herein. Moreover, it is possible that the consumer communications device 514 may be a wireless mobile communications device (e.g., smart phone, tablet, etc.) that accesses the above-described functionality via a wireless communications network (e.g., cellular, CDMA, GSM, Wi-Fi, Bluetooth, etc.). One or more firewalls 516 may be provided between the application server 502 and the network 512 to protect the web application server 502 from hacking or other malicious activity that may adversely affect the web application server 502. The firewall 516 may include a feature for authenticating the installer and consumer before allowing access to the web application server 502.

The flowcharts and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems which perform the specified functions or acts, or combinations of special purpose hardware and computer instructions.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to embodiments of the invention in the form disclosed. Many modifications and variations will be apparent to those of ordinary skill in the art without departing from the scope and spirit of embodiments of the invention. The embodiment was chosen and described in order to best explain the principles of embodiments of the invention and the practical application, and to enable others of ordinary skill in the art to understand embodiments of the invention for various embodiments with various modifications as are suited to the particular use contemplated.

Although specific embodiments have been illustrated and described herein, those of ordinary skill in the art appreciate that any arrangement which is calculated to achieve the same purpose may be substituted for the specific embodiments shown and that embodiments of the invention have other applications in other environments. This application is intended to cover any adaptations or variations of the present invention. The following claims are in no way intended to limit the scope of embodiments of the invention to the specific embodiments described herein.

What is claimed is:

1. A method for ordering and entering measurements for installing coverings for architectural openings, comprising:
receiving, by a computer system, consumer information for measurement of at least one architectural opening associated with a consumer;
transmitting, by the computer system, a measurement request to a communications device of a covering installer for scheduling measurement of the at least one architectural opening in response to receiving the consumer information;
presenting, by the computer system, a measurement GUI for entering measurements of the at least one architectural opening and other information associated with the at least one architectural opening;
storing the measurements for the at least one architectural opening in a database;
transmitting, by the computer system, a request to the consumer to access a website for selecting a covering for the at least one architectural opening based on the measurements; and
presenting, by the computer system, a covering selection GUI for selecting and ordering the covering for the at least one architectural opening.

2. The method of claim 1, wherein presenting the covering selection GUI comprises presenting a plurality of covering options to the consumer without the measurements of the at least one architectural opening.

3. The method of claim 1, wherein the presenting the measurement GUI and the storing the measurements are performed prior to the transmitting the request to the consumer and the presenting the covering selection GUI.

4. The method of claim 1, wherein the presenting the covering selection GUI for selecting and ordering the covering does not include the stored measurements.

5. The method of claim 1, wherein the presenting the covering selection GUI for selecting and ordering the covering comprises:
presenting at least one architectural opening identifier for the at least one architectural opening; and
presenting at least one covering option for the at least one architectural opening.

6. The method of claim 5, wherein the at least one architectural opening identifier comprises at least one of a room identifier or an architectural opening identifier.

7. A method for ordering and entering measurements for installing coverings for architectural openings substantially as described and shown herein.

8. A system for ordering and entering measurements for installing coverings for architectural openings, comprising:
at least one processor;
an installer module operating on the at least one server for receiving and storing measurements for at least one architectural opening and other information associated with the at least one architectural opening;
a database for storing the measurements for the at least one architectural opening and the other information; and
an e-commerce module operating on the server for selecting and ordering at least one covering for the at least one architectural opening;
wherein the e-commerce module is operable to present to a consumer a plurality of options for the at least one covering based at least in part on the control measurements.

9. The system of claim 8, wherein the installer module comprises a module for presenting a measurement GUI for entering measurements of the at least one architectural opening and the information associated with the at least one architectural opening.

10. The system of claim 9, wherein the e-commerce module comprises a module for presenting a covering selection GUI for selecting and ordering the covering for the at least one architectural opening.

11. A system for ordering and entering measurements for installing coverings for architectural openings substantially as described and shown herein.

12. A computer program product for ordering and entering measurements for installing coverings for architectural openings, the computer program product comprising:
a computer readable storage medium having computer readable program code embodied therewith, the computer readable program code comprising:
computer readable program code configured to receive consumer information for measurement of at least one architectural opening associated with a consumer;
computer readable program code configured to transmit a measurement request to a communications device of a covering installer for scheduling measurement of the at least one architectural opening in response to receiving the consumer information;
computer readable program code configured to present a measurement GUI for entering measurements of the at least one architectural opening and other information associated with the at least one architectural opening;
computer readable program code configured to store the measurements for the at least one architectural opening in a database;
computer readable program code configured to transmit a request to the consumer to access a website for selecting a covering for the at least one architectural opening based on the measurements; and
computer readable program code configured to present a covering selection GUI for selecting and ordering the covering for the at least one architectural opening.

13. The computer program product of claim 12, further comprising computer readable program code for presenting a plurality of covering options to the consumer without the measurements of the at least one architectural opening.

14. A computer program product for ordering and entering measurements for installing coverings for architectural openings substantially as described and shown herein.
